(19) United States
(12) Patent Application Publication
(10) Pub. No.: US 2006/0160530 A1
(43) Pub. Date: Jul. 20, 2006

(54) Silent radio communications

(76) Inventor: Roger E. Tipley, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/038,924

(22) Filed: Jan. 19, 2005

(51) Int. Cl. H04M 3/00

(52) U.S. Cl. 455/418

(57) ABSTRACT

A method and apparatus for providing silent communications allows for a radio user to transmit preprogrammed audio messages to a calling unit. A wireless communication device includes a receiver for receiving a call from a calling unit and a transmitter. A user control coupled to the transmitter when activated causes a preprogrammed audio message to be transmitted to the calling unit in order to establish a silent communication conversation with the calling unit, further preprogrammed audio messages can be transmitted in order to continue the silent conversation by activating the user control or a second user control.

### FIELD OF THE INVENTION

The invention relates in general to the field of communications and more particularly to silent radio communications.

### BACKGROUND

With the increased popularity of wireless communications, it is not uncommon to see people using cellular telephones in almost every place one goes. Although radio communications is very useful and a productivity enhancement tool, it also can become a problem on some occasions. In some situations, such as when a person is in a movie or at an important meeting, it can be very difficult for a person receiving a call to answer the call. Even when a radio communication device is placed in a silent ring or vibration mode, the person receiving the call has to make some noise to answer the call, or face losing the call. Answering the call, of course, may not be desirable when the party receiving the call is at a location in which talking would be inappropriate.

### BRIEF DESCRIPTION OF THE DRAWINGS

For a detailed description of exemplary embodiments of the invention, reference will now be made to the accompanying drawings in which:

FIG. 1 shows a block diagram of a radio in accordance with an embodiment of the invention;

FIG. 2 shows a front view of the radio of FIG. 1 in accordance with an embodiment of the invention;

FIG. 3 shows a flowchart highlighting some of the steps in performing silent radio communications in accordance with an embodiment of the invention; and

FIG. 4 shows a diagram of a communication system in accordance with an embodiment of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

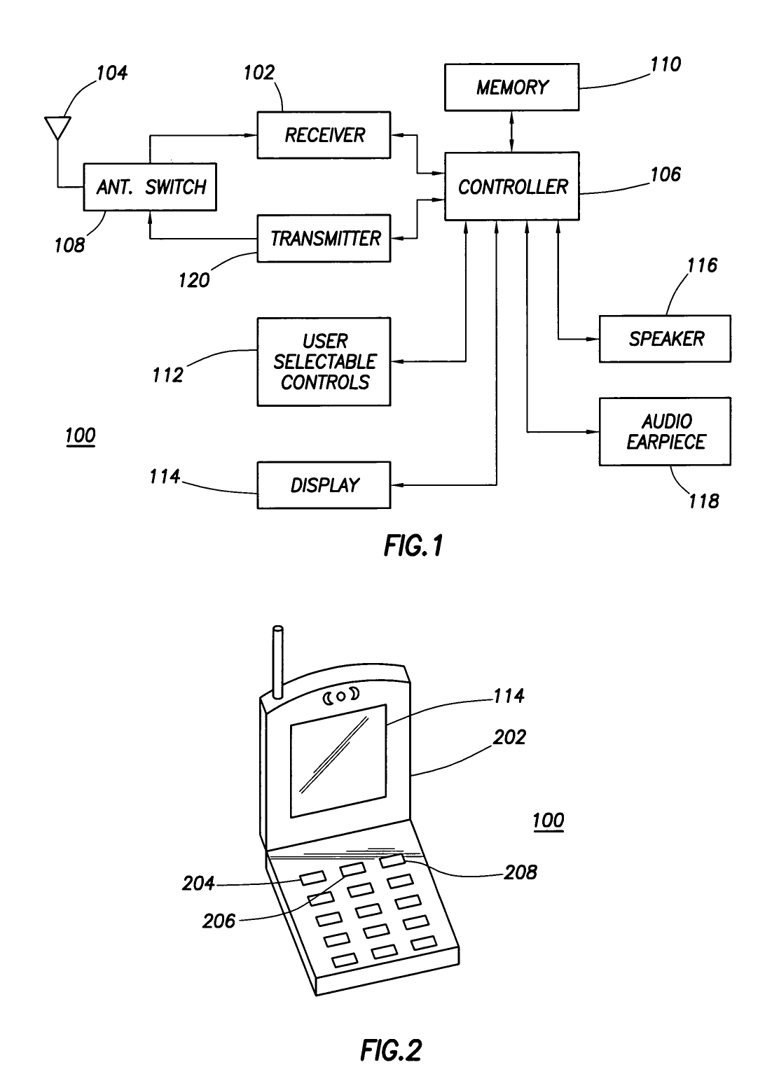

Referring now to FIG. 1, there is shown a block diagram of a radio communication device such as a cellular radio telephone or combination personal data assistant (PDA) cell phone (also referred to herein as a radio) 100 in accordance with an embodiment of the invention. Radio 100 includes a receiver 102 and transmitter 120 which are selectively coupled to antenna 104 via antenna switch 108. A controller 106 provides the overall control of radio 100 and can comprise, as an illustrative example, a microprocessor or microcontroller. Radio 100 also includes a display 114 coupled to the controller 106 for displaying information to the radio user as well as a speaker 116, also coupled to controller 106, for outputting audio information. User selectable controls 112, which can include a keypad and other user activated switches, allow the radio user to input information to the radio 100. An audio earpiece 118 can be coupled to the controller 106 as desired, and, when included, the earpiece 118 receives audio instead of speaker 116. If desired, audio can be provided to both the earpiece 118 and to the speaker 116. Radio 100 also includes memory 110, which can include one or more of random access memory (RAM), read-only memory (ROM), as well as other types of memory such as Flash memory.

In FIG. 2, there is shown a front view of radio 100. Radio 100 as shown comprises a cellular telephone that includes a flip portion 202 and is referred to in the industry as a “flip-phone.” Note that although radio 100 is shown as a flip phone, embodiments of the present invention can be used with any type of radio communication device including phones that do not have a flip feature. In accordance with an embodiment of the invention, one or more user selectable controls 112, such as push-button switches 204-206, allow the radio user upon receiving a call to activate one of the push-button switches 204-206 and cause the automatic transmission of a pre-programmed audio message. For example, activating switch 204 can cause the audio message “hello” to be transmitted back to the radio that had placed the call to radio 100. Activation of switch 206 as another illustrative example could cause a message such as “I presently can not talk, I will call you back as soon as I get a chance” to be automatically transmitted to the calling party. In another embodiment, the activation of switches 204-206 can cause different audio responses such as “yes,” “no,” and “okay” to be transmitted. The use of these preprogrammed messages allows a radio user to have an ongoing “silent” conversation with the caller without having to say a word and disturb those around the radio user. This ability of performing a silent conversation is useful in situations in which the person receiving a call desires not to make any noise when responding to a call.

In other embodiments, the preprogrammed audio messages can be selected by the radio user by using one or more of the radio control switches to scroll down a menu of messages that are displayed on display 114. In still other embodiments, the preprogrammed audio messages can be selected by using a touch sensitive display, using a stylus, or by the radio utilizing voice recognition to determine which preprogrammed audio message the user wants to select. The menu list that is displayed on display 114 can display in alphanumeric text form the entire audio message that is preprogrammed in memory, a portion of the message, or an alias for the message. For example, if a preprogrammed audio message states, “I am currently in a meeting and can not respond right now, I will call you back once I get out of the meeting,” the display may display “Currently in a meeting” as the menu choice item that can be selected by the radio user. Once the user has selected the menu choice, the audio message associated with the selected choice is automatically transmitted to the calling party, be it another radio in the communication system, or a land-line telephone that has established a call with the radio user as illustrative examples.

In some embodiments, the audio messages used, are pre-loaded in the radio and not changeable by the user. In other embodiments, a user can record messages and label the messages so that the labels can be displayed for user selection. The audio messages can be stored locally in the radio memory 110 or, in another embodiment, the audio messages can be stored in a remote location such as a message server (discussed below) which is part of a radio communication system. The audio messages can be stored in a variety of formats. For example, the audio message may be digitized and compressed for storage to provide for more efficient storage.

In the event audio messages are stored remotely at a central location such as a message server, upon the radio user selecting a message either by pressing a push button switch located on the radio, or scrolling down a list of available audio messages shown in the display, once the radio user selects the message, the message can in one embodiment be automatically transmitted to the calling radio by the communication system. In another example, the message is first sent and loaded into the radio that selected the message for subsequent transfer to the calling radio.

In another embodiment of the invention, whenever the flip portion 202 of phone 100 is opened, an audio message is automatically transmitted to the calling radio(s). This ability, for example, can be programmed in advance by the radio user whenever the radio user is going to enter a location or event in which talking in the cell phone is inadvisable. The transmission of a message on opening (or closing the flip portion in another embodiment) can be combined with a calendar feature found in the radio 100. For example, when entering meeting information in the calendar feature of the phone, the user can select the silent communication feature described herein. As a result, the telephone will enter a silent mode of operation during the period of time designated on the calendar. Some phones may have a calendar which is managed by the controller 112. Other phone's calendar feature may be programmed by synchronizing the phone to a desktop computer that has calendar information that is loaded onto the phone. During this silent mode of operation period, radio 100 could be automatically placed in a vibration mode and cause the opening of the flip 202 or the activation of another radio control to automatically transmit a message to the calling party informing the party of the silent mode situation. The opening of the flip 202 on radio 100 (or the pressing of a “Answer or Send” button or other means to answer a non-flip phone) could cause for example the transmission of a message to the calling party informing it that for example “I am in a meeting, hold on and I will respond to you using my radio's silent mode feature.” At this point the user of radio 100 can don the earpiece 118, and start sending preprogrammed audio messages to the calling party by selecting from one or more preprogrammed messages. In this would allow the radio user to conduct a limited “silent” conversation with the calling party without disrupting those around the radio user.

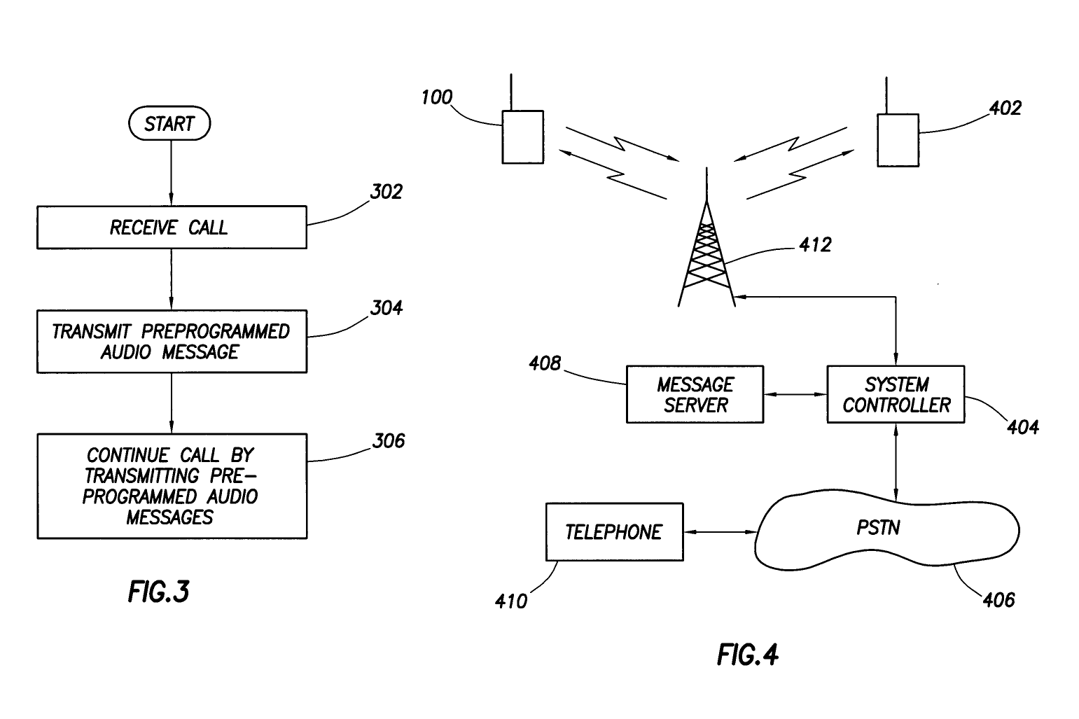

FIG. 3 show a flowchart highlighting some of the steps taken during a communication session. In 302, the radio receives an incoming call. In 304, in response to the incoming call, the radio user causes the transmission of a preprogrammed audio message back to the calling party. As previously mentioned, the radio user can cause the transmission of a preprogrammed audio message by activating a radio control, opening the flip on the radio, or some other similar action. The call can be continued by the radio user in 306, by the radio user responding to the caller's comments by activating other radio controls which cause other messages to be transmitted back to the caller. In this way the radio user can conduct a silent conversation with the calling party.

Referring now to FIG. 4, there is shown a simplified block diagram of a communication system 400 in accordance with an embodiment of the invention. The communication system includes first and second radios 100, 402 which can comprise cellular telephones. A communication site 412 and system controller 404 provide the necessary infrastructure for allowing radio 100 to communicate with radio 402. In one embodiment, a message server 408 stores the pre-programmed audio messages that radio 100 can transmit to radio 402 or land line telephone 410. As previously mentioned, the audio messages can be stored locally at the radios themselves, or some of the messages can be stored locally in the radios themselves and some can be stored in the message server 408. Either of radio 100 or 402 can communicate with a landline telephone 410 via the Public Switched Telephone Network (PSTN) 406. In another embodiment, one of the radios, for example radio 100 can send a code to another radio, for example radio 402, that causes a previously transmitted preprogrammed audio message from radio 402 to be retransmitted to radio 100 in case radio 100 did not hear the message the first time. In this case, the user of radio 402 could receive some type of notice of this request. In still another embodiment, the preprogrammed messages can be transmitted to more than one radio at a time, for example, a group of phones. This multicast message can be performed for example by the radio establishing a conference call with a predetermined group of radios, or in some systems by simply selecting a group call feature were a predetermined group of radios is preprogrammed into the group and all the radios in the group receive the multicast message.

It should be noted that although the above discussion has highlighted the response to a call using the silent communication technique of the present invention. The invention can also be used where the calling party is the one that starts using preprogrammed audio messages to communicate with another party. This can be used for example, when the calling party needs to communicate with another party but is in a location where he/she can not make very little noise.

The above discussion is meant to be illustrative of the principles and various embodiments of the present invention. Numerous variations and modifications will become apparent to those skilled in the art once the above disclosure is fully appreciated.

What is claimed is:

1. A wireless communication device, comprising:
a receiver for receiving a call from a calling unit;
a transmitter coupled to the receiver; and
a user control coupled to the transmitter, the user control when activated causes a preprogrammed audio message to be transmitted to the calling unit in order to establish a silent communication conversation with the calling unit, further preprogrammed audio messages can be transmitted in order to continue the silent conversation with the calling unit by activating the user control or a second user control.

2. A wireless communication device as defined in claim 1, further comprising:
a memory coupled to the transmitter; and
the memory stores the preprogrammed audio message.

3. A wireless communication device as defined in claim 2, wherein the memory stores a plurality of preprogrammed messages that can be selected amongst and the selected message from amongst the plurality of preprogrammed messages is transmitted by the transmitter.

4. A wireless communication device as defined in claim 1, wherein the user control comprises one or more push button switches.

5. A wireless communication device as defined in claim 1, wherein the wireless communication device includes a flip and the user control comprises the flip.

6. A wireless communication device as defined in claim 1, wherein the preprogrammed message is stored outside of the wireless communication device.

7. A wireless communication device as defined in claim 6, wherein the preprogrammed audio message is stored in a message storage device that is part of a communication system the wireless communication device operates in.

8. A wireless communication device as defined in claim 1, wherein the wireless communication device comprises a cellular telephone.

9. A wireless communication device as defined in claim 1, further comprising:
a display coupled to the memory; and
a label for the preprogrammed message is displayed on the display in order to select the preprogrammed message and cause it to be transmitted.

10. A wireless communication device as defined in claim 1, wherein the wireless communication device operates in a communication system.

11. A wireless communication device as defined in claim 10, wherein the preprogrammed audio message is sent to the wireless communication device from the communication system prior to the preprogrammed audio message being transmitted to the calling unit.

12. A method for performing silent communications at a radio communication device, comprising:
receiving a call at the radio communication device from a calling unit;
activating one ore more user controls in the radio communication device that causes one or more preprogrammed audio message to be sent to the calling unit.

13. A method as defined in claim 12, wherein activating one of the one or more user controls comprises opening a flip section of the radio communication device.

14. A method as defined in claim 12, wherein one of the one or more user controls comprises a control for selecting from amongst one or more choices of preprogrammed audio messages that are displayed on a display found in the radio communication device.

15. A method as defined in claim 12, further comprising:
continuing to communicate with the calling unit by activating user controls in the radio communication device which cause preprogrammed audio messages to be sent to the calling unit.

16. A radio communication device, comprising:
a transmission means for transmitting messages;
a memory means coupled to the transmitter, the memory means having one or more preprogrammed audio messages stored therein; and
a user control means coupled to the memory means, the user control means when activated causes one of the one or more preprogrammed audio messages to be transmitted by the transmission means.

17. A radio communication device as defined in claim 16, further comprising:
a display means coupled to the memory means for displaying information relating to the one or more preprogrammed audio messages so a user of the radio communication device can select from amongst the one or more preprogrammed audio messages.

18. A radio communication device as defined in claim 16, wherein the radio communication device comprises a cellular telephone.

19. A radio communication device as defined in claim 17, wherein the cellular telephone includes a flip and the user control comprises the flip, and when the flip is opened a preprogrammed audio message is transmitted by the transmission means.

20. A radio communication device as defined in claim 16, further comprising:
a receiver means coupled to the transmission means for receiving codes; and
upon the receiver means receiving a code, one of the one or more preprogrammed audio messages is transmitted by the transmission means.

21. A radio communication device as defined in claim 16, wherein the transmission means transmits the one or more preprogrammed messages to a predetermined group of radio communication devices.

22. A radio communication device as defined in claim 16, further comprising:
a receiver means coupled to the transmission means for receiving messages; and
upon the receiver means receiving a message, the transmission means retransmits the one or more preprogrammed audio messages.

23. A radio communication device as defined in claim 16, further comprising:
a calendar means coupled to the user control means for programming the radio communication device into a silent mode of operation during predetermined periods of time.

24. A radio communication device as defined in claim 23, wherein when the radio communication device is in a silent mode of operation as determined by the calendar means, the radio communication device automatically responds to an incoming call with one or more of the preprogrammed audio messages.

25. A server, comprising:
a memory for storing a plurality of preprogrammed audio messages; and
a port for receiving a request to transmit one or more of the plurality of preprogrammed audio messages to one or more radio communications devices.

26. A server as defined in claim 25, wherein the request to transmit one or more of the plurality of preprogrammed audio messages is sent by a radio communication device who is responding to call it has received.
